(19) United States
(12) Patent Application Publication
(10) Pub. No.: US 2011/0063327 A1
(43) Pub. Date: Mar. 17, 2011

(54) DISPLAY AND IMAGER DISPLAYING AND MAGNIFYING IMAGES ON THEIR SCREEN

(75) Inventor: Saki Shimizu, Saitama (JP)

(73) Assignee: HOYA CORPORATION, Tokyo (JP)

(21) Appl. No.: 12/869,188

(22) Filed: Aug. 26, 2010

(30) Foreign Application Priority Data
Sep. 11, 2009 (JP) 2009-210678

(51) Int. Cl. G09G 5/00

(52) U.S. Cl. 345/660

(57) ABSTRACT

A display is provided having a screen and an operating part. The screen displays three or more selection items. The operating part is used to select two or more items among the selection items displayed on the screen. The screen displays and magnifies the two or more selection items that are selected.

### BACKGROUND OF THE INVENTION

1. Field of the Invention

The present invention relates to a display that displays and magnifies an item.

2. Description of the Related Art

U.S. Pat. No. 7,430,008 discloses a digital camera that has a display having a touch panel. When a user touches the touch panel according to a predetermined touch pattern, the digital camera detects the touch pattern on the touch panel and changes a displaying mode based on the touch pattern.

However, a user cannot arbitrarily select any point on the screen because the digital camera detects touches based on the predetermined pattern.

### SUMMARY OF THE INVENTION

An object of the present invention is to provide a display and an imager that displays and magnifies a plurality of selected items with ease.

A display is provided having a screen and an operating part. The screen displays three or more selection items. The operating part is used to select two or more items among the selection items displayed on the screen. The screen displays and magnifies the two or more selection items that are selected.

An imager is provided having a display. The display comprises a screen and a touch panel. The screen displays three or more thumbnail images. The touch panel is provided on said screen, and selects two or more images among three or more thumbnail images displayed on the screen when the touch panel is touched. The screen displays and magnifies the images corresponding to the touched area of the touch panel.

### BRIEF DESCRIPTION OF THE DRAWINGS

The objects and advantages of the present invention will be better understood from the following description, with references to the accompanying drawings in which:

FIG. 1 is a schematic view of an imager according to the present embodiment;

FIG. 2 shows a screen that displays sixteen thumbnail images;

FIG. 3 shows a screen displaying thumbnail images when a user draws a circular arc on the touch panel;

FIG. 4 shows a screen that displays and magnifies eight selected images in order of their file names;

FIG. 5 shows a screen that displays and magnifies eight selected images in the order corresponding to their order of selection, which is the order in which the items were touched on the touch panel;

FIG. 6 shows a screen displaying thumbnail images when a user draws a circle on a touch panel;

FIG. 7 shows a screen that displays and magnifies eight selected images and one image that is surrounded by the eight selected images, in the order of file name;

FIG. 8 is a flowchart of a display process;

FIG. 9 is a schematic view of an imager having an operating part that is provided independently from a touch panel; and

FIG. 10 shows a screen that displays thumbnail images with checkboxes on each thumbnail image.

### DESCRIPTION OF THE PREFERRED EMBODIMENTS

The present invention is described below with references to the embodiment shown in the drawings.

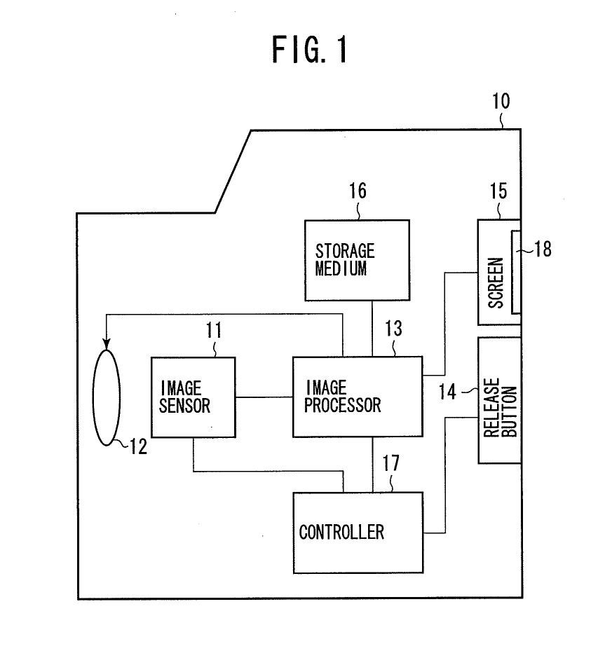

A digital camera 10 is an imager according to the embodiment shown in FIG. 1, and comprises an imaging sensor 11, a focusing lens 12, an image processor 13, a release button 14, a screen 15 with a touch panel 18, a storage medium 16, and a controller 17.

Reflected light from an object strikes the imaging sensor 11 after passing through the focusing lens 12, so that the imaging sensor 11 converts an optical image to an electric image signal and outputs the signal. The image processor 13 creates image data by processing the image signal. The image data is then sent to the screen 15, upon which an image is displayed based on the image data. In the case where the digital camera carries out such procedures for one frame, the screen 15 displays a through image, which is called a live view. The controller 17 controls each part of the digital camera 10, e.g. the image processor.

When the release button 14 is depressed halfway, the image processor 13 brings an object into focus by controlling the focusing lens 12, and calculates exposure conditions, e.g. aperture value and exposure time, etc., based on a brightness signal included in the image signal. While the focusing lens 12 is focused on an object, the image processor 13 directs the movement of the focusing lens 12 along its axis while calculating contrast values based on the brightness signal from a predetermined period. Then, when the image processor 13 determines that an object is in focus of the focusing lens 12 and the contrast value is at its maximum, the focusing lens 12 is fixed it its current position that is focused on the object.

When the release button 14 is fully depressed, the image processor 13 keeps the object in focus of the focusing lens 12 while the imaging sensor 11 captures an image under the calculated exposure conditions. The image processor 13 then creates image data by processing the image signal, and a still image based on the image date is displayed on the screen 15. The image file including the image data is stored in the storage medium.

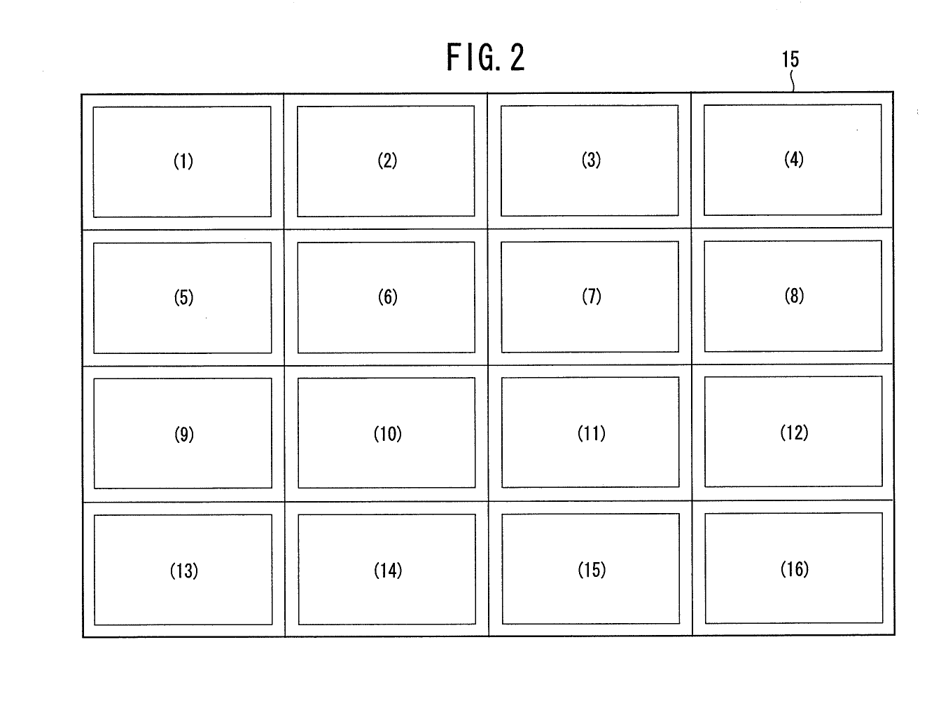

The screen 15 is controlled by the controller 17, so as to display a live view, an image stored in the storage medium 16, a magnified image or a plurality of thumbnail images. FIG. 2 shows the screen 15 displaying 16 thumbnail images. In this particular case, the thumbnail images are aligned in the order of their filenames, from 1 to 16, which were decided according to their order of photographing.

The touch panel 18 is provided on the surface of the screen 15. By touching one or more thumbnail images displayed on the screen 15, a user selects which images on the touch panel 18 are displayed and magnified. By continuously touching the touch screen and tracing a circular pattern, a user can select all touched images and those inside the circular pattern to be displayed and magnified on the screen 15. All of the displayed images are magnified as large as possible.

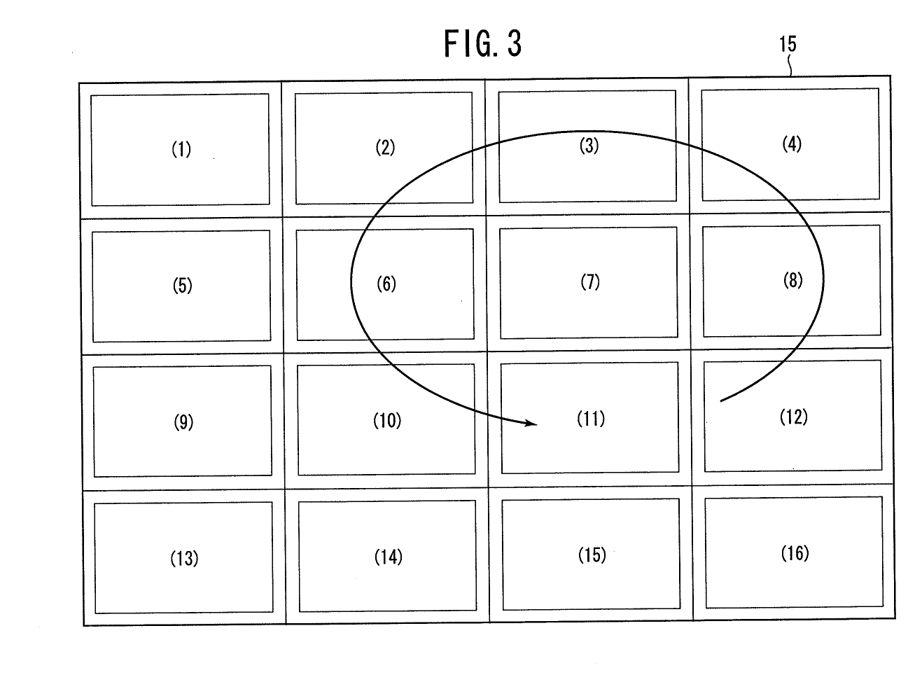

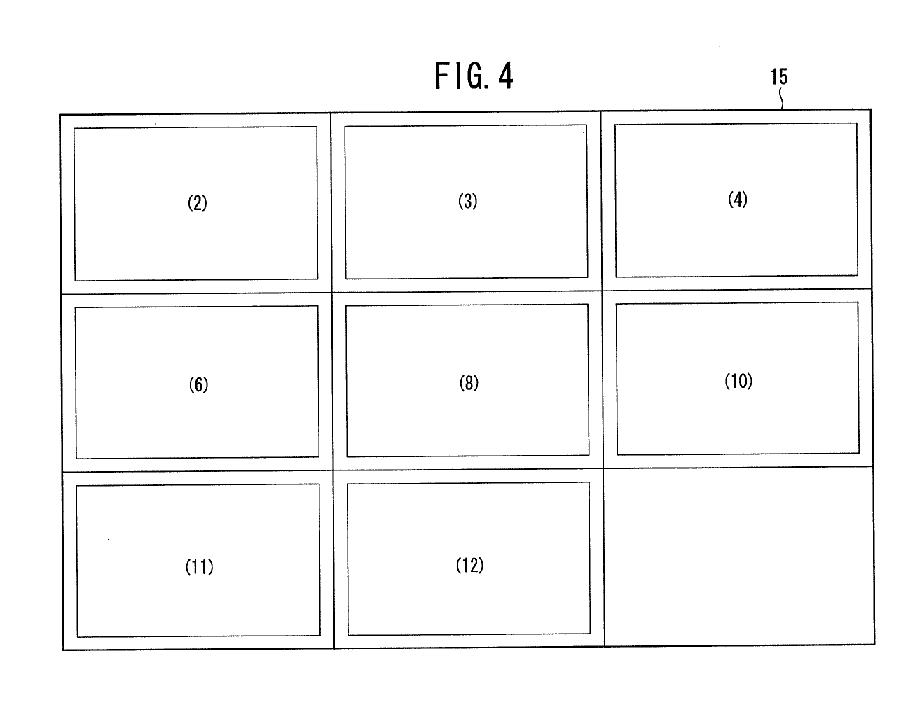

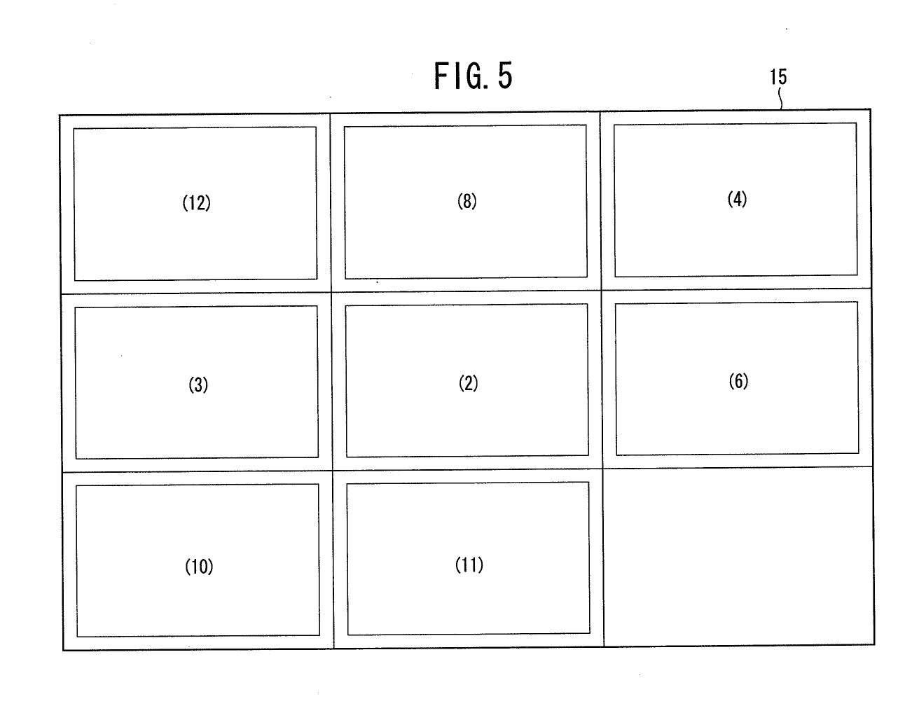

For example, when a user traces a circular pattern on the screen 15 by touching the thumbnail images in the order of 12, 8, 4, 3, 2, 6, 10 and 11, as illustrated by the arrow in FIG. 3, the screen 15 displays and magnifies only these images (refer to FIGS. 4 and 5).

FIG. 4 shows the screen 15 when it displays and magnifies the images in the order corresponding to the rank predetermined for each image. For example, the images are displayed in the order 2, 3, 4, 6, 8, 10, 11, 12. FIG. 5 shows the screen 15 when it displays and magnifies the images in the order corresponding to their touched order.

For example, the images are displayed in the order 12, 8, 4, 3, 2, 6, 10, 11. In this case, a user not only selects which images are to be magnified, but also determines their order of display.

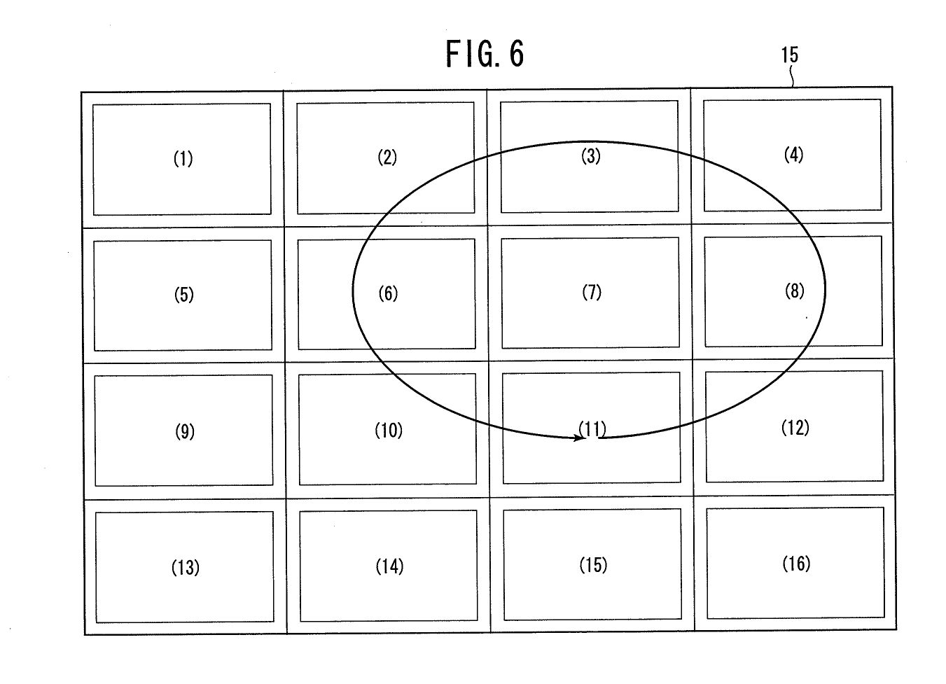

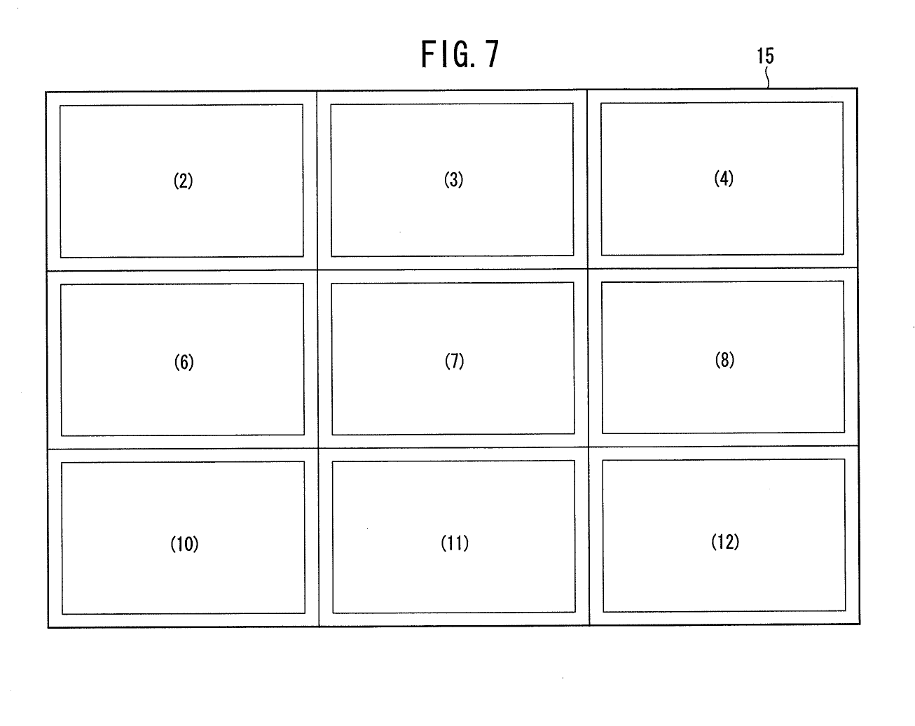

When a user touches the thumbnail images on the screen 15 in the order 11, 12, 8, 4, 3, 2, 6, 10, 11 as illustrated by the arrow in FIG. 6, i.e. as drawing circle, the screen 15 displays and magnifies these touched images along with image 7 that is encircled by the circular pattern traced on the touch panel 18. FIG. 7 shows screen 15 displaying and magnifying these images. By properly tracing a circular pattern, a user can determine whether or not the image positioned inside the pattern is selected and magnified.

A user selects images while thumbnail images are displayed on the screen 15, as illustrated in FIGS. 3 and 6, so that the images that a user intends to view or make comparisons with are displayed and magnified.

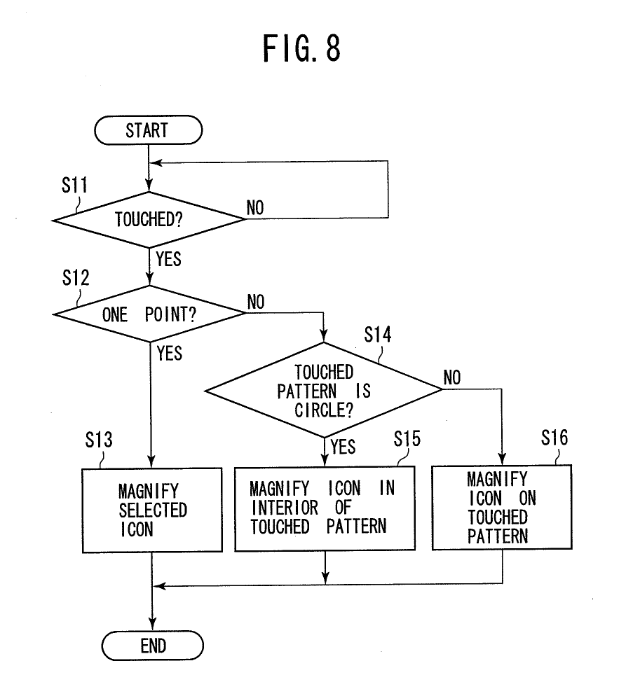

The display process is described hereinafter with reference to FIG. 8. The display process is the process of the screen 15 displaying and magnifying images based on an area that is specified by the touch of a user, and starts when the digital camera 10 is powered on.

In Step S11, when the screen 15 displays thumbnail images, the controller 17 determines whether or not a user touches the touch panel 18. In the case that the touch panel 18 is not touched, Step S11 is repeated until the touch panel 18 is touched. In the case that the touch panel 18 is touched, the process continues to Step S12.

In Step S12, the controller 17 determines whether a user touches only one single image on the touch panel 18. In the case that a user touches only one image, the process continues to Step S13. Otherwise a plurality of images is touched and the process proceeds to Step S14.

In Step S13, the controller 17 directs the screen 15 to display the image that is selected by a user.

In Step S14, the controller 17 determines whether or not a pattern touched on the touch panel 18 by a user for a predetermined period forms a circle. In the case a circle is formed, the process continues to Step S15, otherwise it proceeds to Step S16.

In Step S15, the screen 15 displays and magnifies eight images that are on the circular pattern and one image that is surrounded by the selected eight images, in other words, encircled by the circular pattern.

In Step S16, the screen 15 displays and magnifies images on the pattern which is circular arc, not a complete circle.

The thumbnail images are too small to observe in detail. However, according to the embodiment, the screen 15 magnifies and displays any image that a user desires to observe in detail. Therefore, a user can easily observe images in detail. According to the embodiment, a user views thumbnail images and intuitively manipulates the touch panel 18 to select images to be magnified.

In this embodiment, the thumbnail images are displayed and magnified; however, icons for the configuration of the digital camera 10, i.e. a configuration menu, may instead be magnified and displayed on the screen 15.

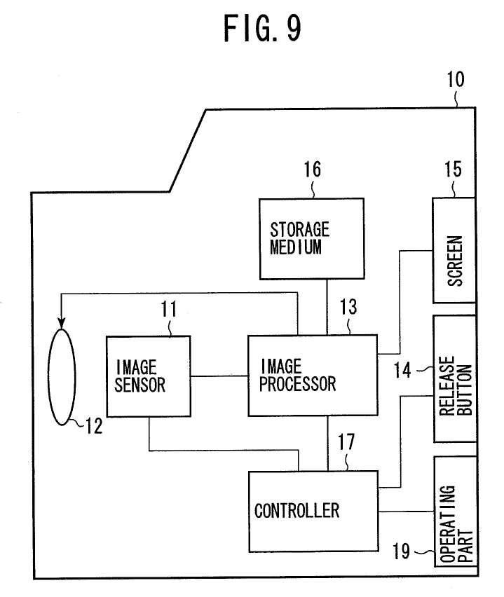

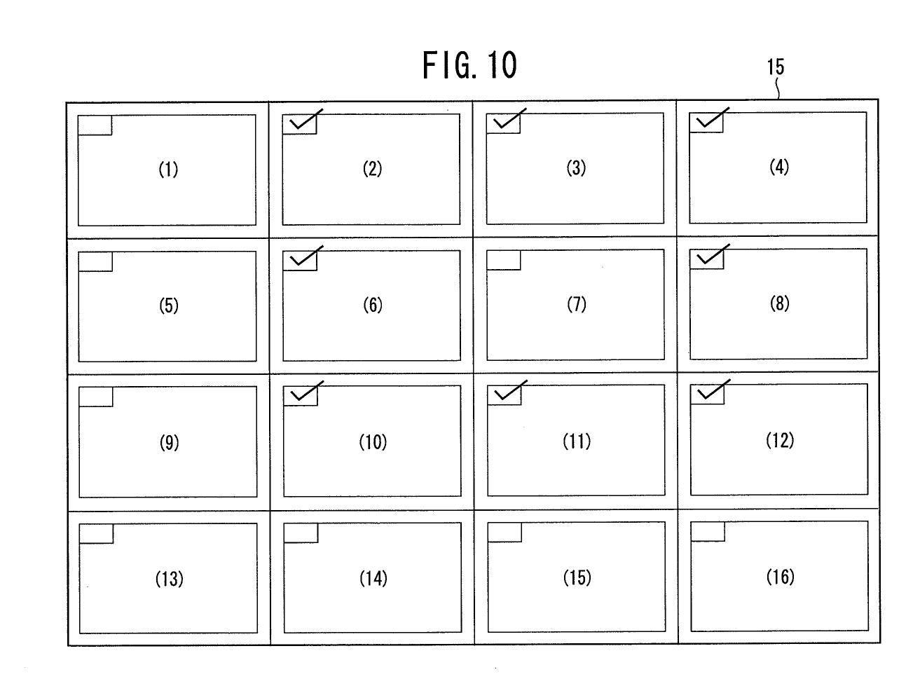

As shown in FIG. 9, the digital camera 10 may comprise an operating part 19 that a user operates by marking or unmarking a checkbox on a thumbnail image to select an image to be magnified (refer to FIG. 10).

Concerning the selection of a thumbnail image, the digital camera 10 may display a determination icon on the screen 18. The digital camera 10 determines selected images after a user touches the touch panel 18 and the determination icon.

In the embodiment, the digital camera 10 having the screen 15 is described as one example of the invention, however, the screen can be applied to other devices that can display three or more items on one screen, and then magnify and display two or more selected items on one screen.

Although the embodiment of the present invention has been described herein with references to the accompanying drawings, obviously many modifications and changes may be made by those skilled in the art without departing from the scope of the invention.

The present disclosure relates to subject matter contained in Japanese Patent Application No. 2009-210678 (filed on Sep. 11, 2009), which is expressly incorporated herein, by reference, in its entirety.

1. A display comprising:
a screen that displays three or more selection items; and
a operating part that is used to select two or more items among the selection items displayed on said screen;
said screen displays and magnifies the two or more selection items that are selected.

2. The display according to claim 1, wherein said operating part is a touch panel that is provided on said screen, and an item is selected from the selection items when the touch panel is touched.

3. The display according to claim 2, wherein said screen displays and magnifies the selection item corresponding to the touched area of the touch panel.

4. The display according to claim 3, wherein said screen displays and magnifies the selection item corresponding to the interior of a circular pattern touched on the touch panel.

5. The display according to claim 3, wherein said screen displays and magnifies the selection items in the order corresponding to the order of selection, which is the order in which the items were touched on the touch panel.

6. The display according to claim 3, wherein said screen displays and magnifies the selection items in the order corresponding to the rank predetermined for each selection item.

7. An imager comprising:
a display comprising a screen that displays three or more thumbnail images, and a touch panel that is provided on said screen, and selects two or more images among three or more thumbnail images displayed on the screen when the touch panel is touched; and
the screen displaying and magnifying the images corresponding to the touched area of the touch panel.

8. The imager according to claim 7, wherein the screen displays and magnifies the images corresponding to the interior of a circular pattern touched on the touch panel.

9. The imager according to claim 7, wherein the screen displays and magnifies the images in the order corresponding to the order of selection, which is the order in which the items were touched on the touch panel.
